(19) United States
(12) Patent Application Publication
(10) Pub. No.: US 2012/0240307 A1
(43) Pub. Date: Sep. 27, 2012

(54) Hygienic hand protectors

(76) Inventors: Georgette Terrell, Green Oaks, IL (US); Patricia Thompson, Katy, TX (US); Ralph Wilkerson, Lybertyville, IL (US)

(21) Appl. No.: 13/065,515

(22) Filed: Mar. 24, 2011

(51) Int. Cl. A41D 19/01; A41D 19/015; A41D 19/00; B25G 1/10

(52) U.S. Cl. 2/158; 16/422; 2/159; 2/167

(57) ABSTRACT

The present invention provides reusable hygienic protective covers for insulating the hands of the user from harmful germs, bacteria, skin-borne infections, and other contaminants that are normally encountered in everyday activities. Included is storage means for insertion and retraction of the covers without user contact with the covers.

This application claims the benefit of U.S. Provisional Application No. 61/241,180 filed on 29 Mar. 2010 and entitled “HYGIENIC HAND PROTECTORS”. This utility application has the same inventors, title, and subject matter as the said Provisional Application.

### BACKGROUND

The background of the invention will be discussed in two parts.

### FIELD OF THE INVENTION

The present invention relates in general to providing insulation from harmful contaminants, and more particularly to reusable hygienic protective covers that protect the hands of the user from germs, bacteria, skin-borne infections, and other contaminants that are normally encountered in everyday activities.

### PRIOR ART

Unsanitary and contagious conditions are encountered almost continually by the general public. Manual contact with handles, knobs, railings, tools or other objects and devices poses the danger of the hands coming in contact with unsafe contagious conditions that have accumulated on the objects or devices. Efforts have been made to provide protection from such conditions, however, such efforts have been less than satisfactory and have not gained wide acceptance by the public. A search of the prior art has not disclosed the hygienic protective covers and methods of use as is disclosed in the present invention, however, protective means of interest are disclosed in U.S. Pat. Nos. 5,722,672 issued to Frederick on 03 Mar. 1998; U.S. Pat. No. 6,065,764 issued to Moseley on 23 May 2000, and U.S. Pat. No. 6,543,794 issued to Tyree on 08 Apr. 2003. It is therefore an object of the present invention to disclose new and unique reusable hygienic protector devices that protect the hands of the user from contagious conditions and that are effective and easy to use.

### SUMMARY

In accordance with the invention there is provided different configurations of protective reusable hand covers that protect the users hands from contagious conditions such as harmful germs, bacteria, skin-borne infections, and other miscellaneous contaminants that are normally encountered in everyday activities. One such configuration is an elongated protective cover as may be variously used on handles or other gripping surfaces of manually operated apparatus such as push carts, door knobs, door handles, gymnasium equipment, or the like. There is also provided a protective glove or mitten as well as an enclosure for the glove or mitten.

### DRAWINGS

FIG. 1 is a perspective view of the protective hand cover of the invention;

FIG. 2 shows the cover of FIG. 1 as used on the handle of a mobile implement;

FIG. 3 is a cross-sectional view taken along 3-3 of the cover and handle of FIG. 2;

FIG. 4 is a view of a smaller version of the protective cover depicted in FIG. 1;

FIG. 5 is a view of the cover depicted in FIG. 4 in the opened state;

FIG. 6 is a view showing secure closure of the cover of FIG. 5;

FIG. 7 shows connection of two of the covers of FIG. 5, one open and one closed;

FIG. 8 is shows the covers depicted in FIG. 5 with one placed inside the other;

FIG. 9 is a cross-sectional view taken along lines 9-9 of FIG. 8;

FIG. 10 shows the cover of the invention illustrating hook and pile closure means;

FIG. 11 is a view of the protective cover of FIG. 10 in the closed position;

FIG. 12 illustrates the protective cover depicted in FIG. 4 as used on a barbell;

FIG. 13 shows the cover of FIG. 4 as used on gymnasium “pull down” equipment;

FIG. 14 shows the cover of FIG. 4 as used on gymnasium “treadmill” equipment;

FIG. 15 shows another cover configuration in accordance with the invention;

FIG. 16 shows the cover of FIG. 15 as used on a door knob;

FIG. 17 shows yet another cover configuration in accordance with the invention;

FIG. 17A shows the cover of FIG. 17 as used on a door handle;

FIG. 17B shows the cover of FIG. 17 as used on a faucet handle;

FIG. 17C shows the cover of FIG. 17 used on the flush handle of a commode;

FIG. 18 shows a protective cover illustrating acceptance of protective gloves; and

FIG. 19 shows the cover of FIG. 18 with gloves inserted in respective pockets.

### DESCRIPTION

The present invention relates to reusable hygienic hand protectors for protecting the hands of users from germs, bacteria, and other contaminants that are normally encountered in everyday activities. In the drawings identical components which have identical functions have been identified with identical reference numerals throughout the several views.

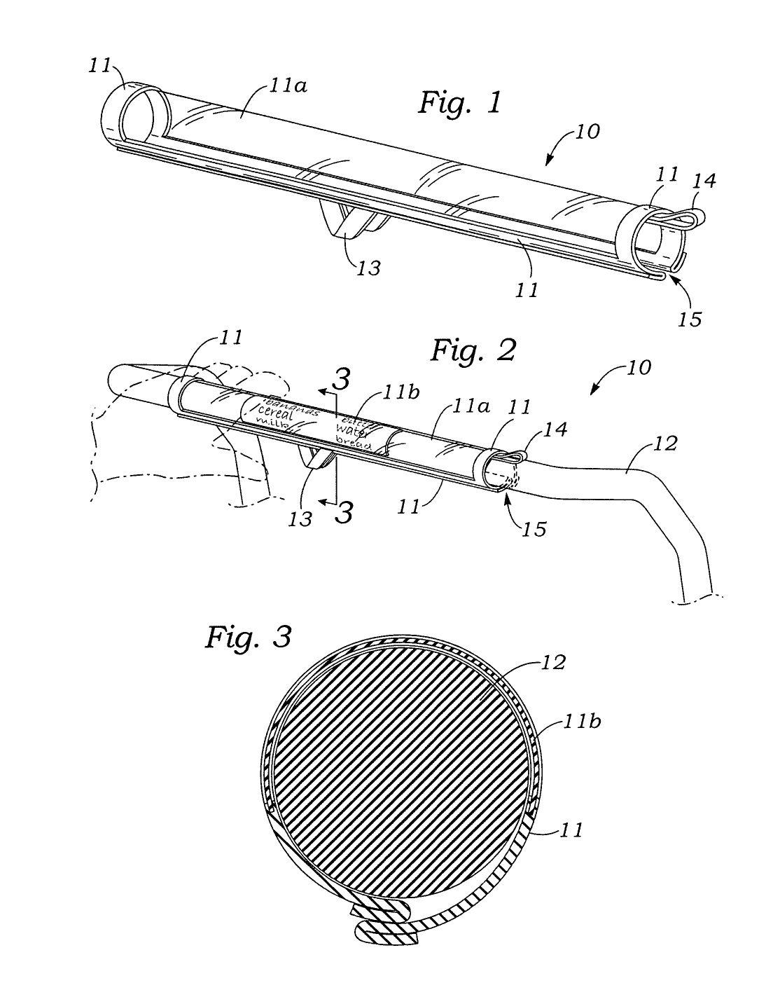

FIG. 1 illustrates in perspective view a reusable one piece protective cover, generally designated 10, in accordance with the invention. The cover 10 is shown in the form of an elongated, hollow, generally tubular, or circular, member. As indicated, cover 10 includes a lengthwise portion 11 having a transparent portion 11 a, center tabs 13, one on each side, end loop tab 14, and lengthwise slit 15 running the length of the cover 10. It is understood that although the transparent portion 11 a is shown the cover 10 may just as well not include the transparent portion 11 a with the lengthwise portion 11 thus being solid throughout. Cover 10 is formed of a flexible resilient plastic material allowing opening along the slit 15 by means of the centrally located pull tabs 13 after which with release of the pull tabs 13 the resilient cover 10 will spring back to its original shape. Although it is understood that other materials may be used for fabrication of the cover 10, denier polyester has been found to be adequate.

FIG. 2 illustrates the cover of FIG. 1 as may be used with a shopping cart or other implement that includes a handle 12 for usage of the implement. In positioning the cover 10 onto the handle 12, without the user touching handle 12, the tabs 13 are used to open the slit 15, the cover 10 is then placed over the handle 12 and the tabs 13 released allowing the resilient cover 10 to spring back and tighten around the handle 12. In removing the cover 10, the reverse procedure is followed, that is, the tabs 13 are used to open the slit 15 to permit removal of the cover 10 from the handle 12, still without touching the handle 12. As indicated, portion 11 of cover 10 may include a transparent portion 11 a of a suitable material to allow viewing of indicia 11b as may be placed on the handle 12, or, as may be positioned between the cover 10 and the handle 12.

FIG. 3 is a cross-sectional view taken along the lines 3-3 of FIG. 2 of the cover 10 mounted onto the handle 12. As shown, the resilient cover 10 has retracted to tighten snugly around the handle 12.

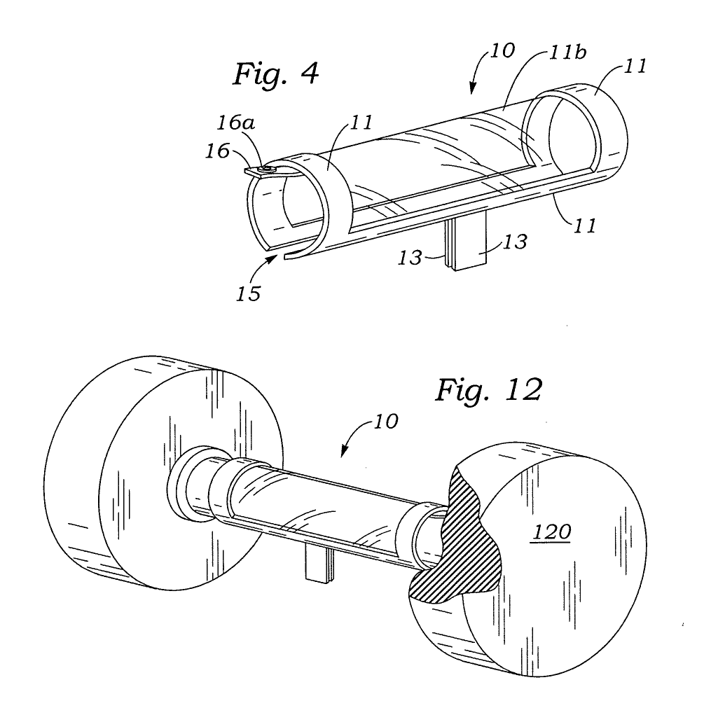

FIG. 4 is a view of a shorter version of the protective cover 10 depicted in FIG. 1 that is more adapted for use with shorter handles such as will be discussed below. For utility purposes end tab 16 having grommet 16a is shown substituted for end loop tab 14.

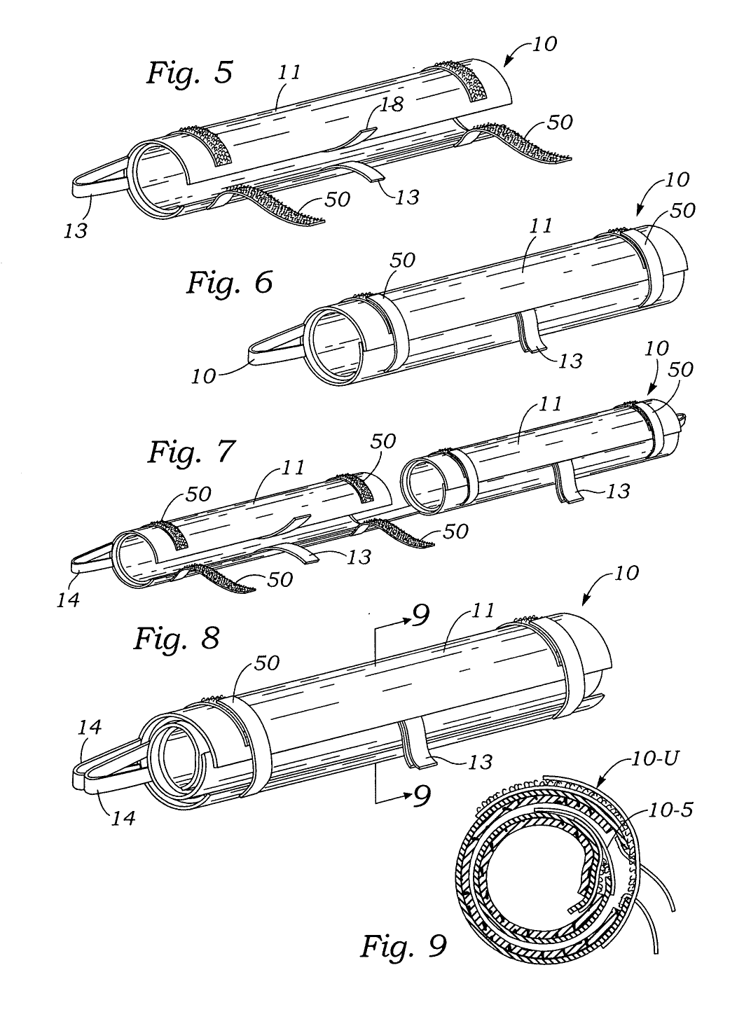

FIG. 5 is a view of the cover 10 of FIG. 4 in the open, or unsecured, state wherein it is shown having hook and pile means 50 for securing closure of the cover 10, thus providing for adjustable closure of the cover 10. Although not shown the cover 10 can include an inner layer of textured rubber or the like for minimizing slippage of the cover 10 when in use.

FIG. 6 is a closed view of the cover 10 of FIG. 5 wherein the hook and pile closure means 50 is mated to securely close the cover 10. It is understood that other types of closure means, such as snaps and the like, as well as removable adhesives, may be employed in the present invention for securing closure of the cover 10.

FIG. 7 is a view of two covers in accordance with the cover 10 of FIG. 5 that are connected in tandem, one having the hook and pile means 50 secured and the other with the hook and pile means 50 unsecured. Although shown connected in tandem as may be convenient for certain usage, the covers 10 may be connected in other manners, or not at all.

FIG. 8 illustrates the secured cover 10 of FIG. 7 placed within the unsecured cover 10 of FIG. 7 and then with the combination then secured by the hook and pile means 50 of the unsecured cover 10, thus providing for convenience in transport and/or storage.

FIG. 9 is a cross-sectional view taken along lines 9-9 of FIG. 8 illustrating the arrangement of the combination of covers 10 for transport and/or storage. The secured cover of FIG. 7 is designated 10-S and the unsecured cover of FIG. 7 designated 10-U.

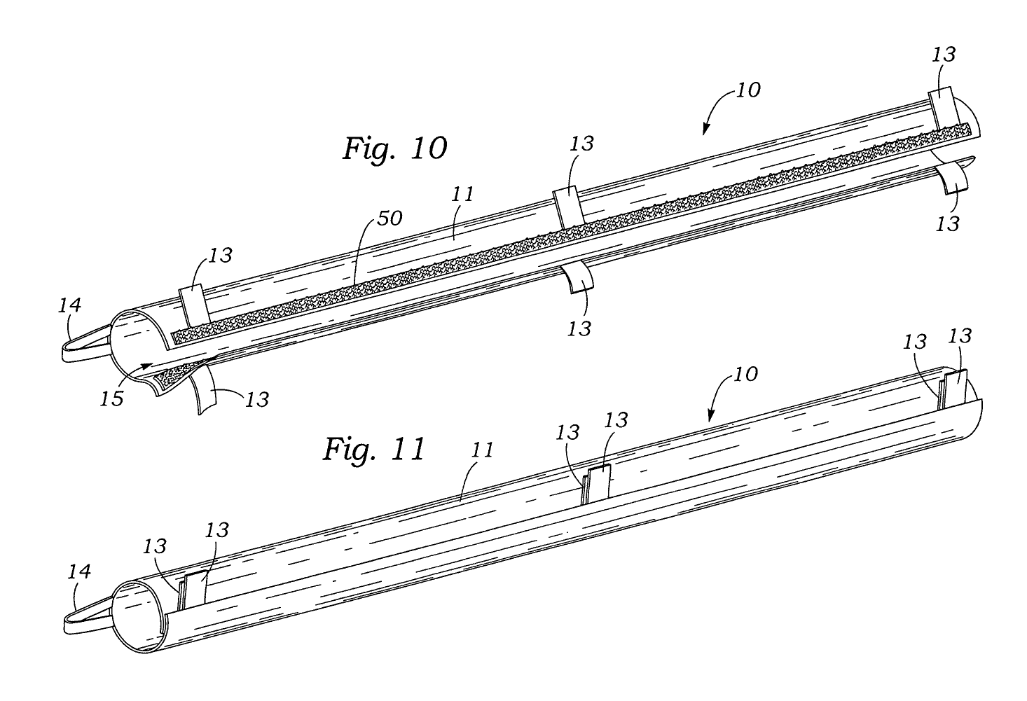

FIG. 10 shows an open, or unsecured, view of a longer version of cover 10 wherein hook and pile means 50 extend lengthwise along cover 10 for closure, and a plurality (three sets) of pull tabs 13 are used for securing the closed cover 10.

FIG. 11 shows the cover 10 of FIG. 10 after closure by the hook and pile means 50.

FIG. 12 illustrates the cover 10 as depicted in FIG. 4 as used on a barbell 120.

FIG. 13 illustrates the cover 10 depicted in FIG. 4 as used on gymnasium “pull down” equipment 130 which shows the use of two covers 10.

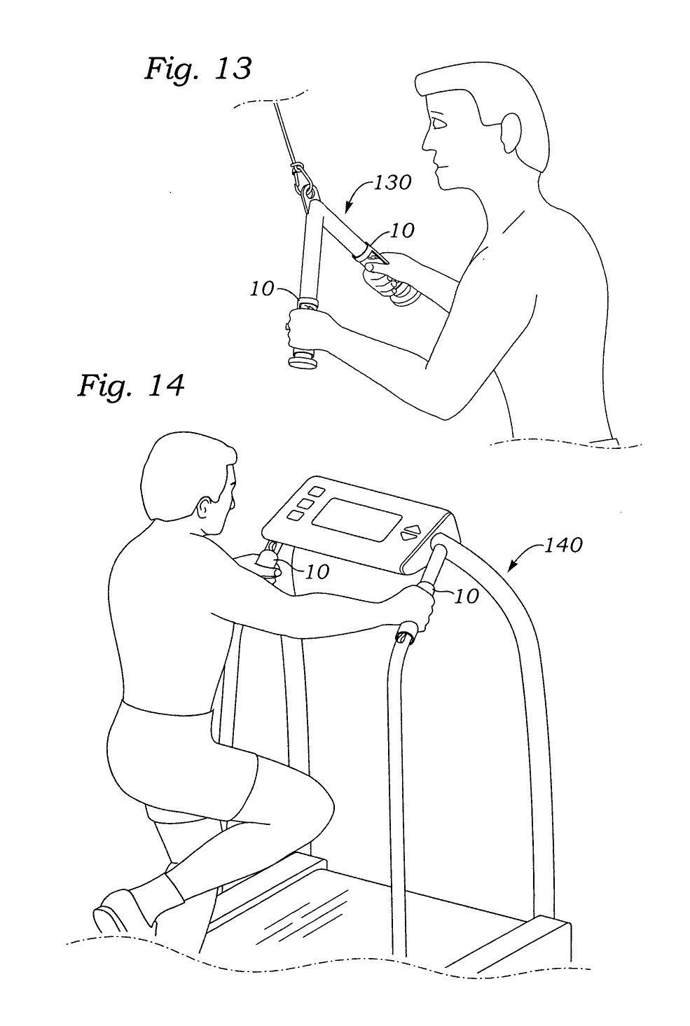

FIG. 14 illustrates the covers 10 (two shown) depicted in FIG. 4 as used on gymnasium “treadmill” equipment 140.

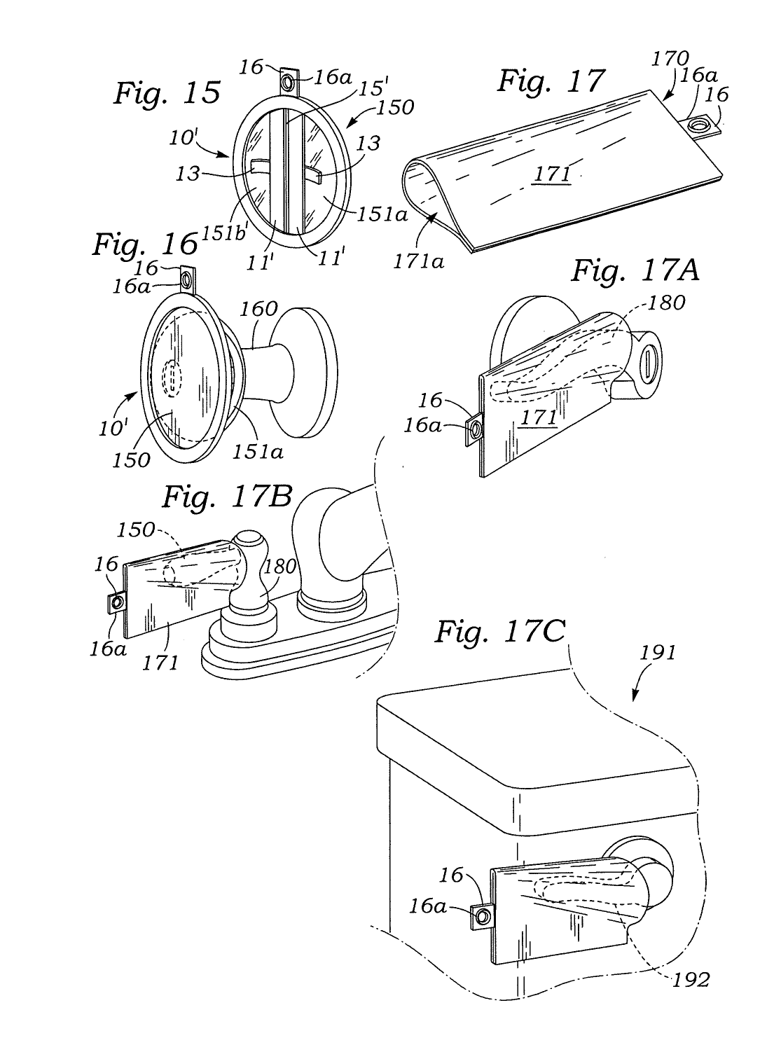

FIG. 15 illustrates a cover 10′ shown configured generally circular to fit over a door knob, or the like. The cover 10′ has a flexible top or outer layer 150 and a separate flexible inner layer generally indicated 151. Inner layer 151 is divided into portions 151a and 151b which are separated by a slit 15′, The portions 151a, 151b are shown as having extending center edges 11′ separated by slit 15′.

FIG. 16 shows the cover 10′ of FIG. 15 as used on a circular door knob 160. Slit 15′ is opened by manipulation of pull tabs 13 whereby the cover 10′ can fit over a contaminated knob or the like, the outer layer covering the top of the knob 160 with the inner layer pulled down over the sides of the knob 160. Although depicted as generally circular the configuration of the cover 10′ may be of any suitable configuration depending on the device to be covered. For instance the cover 10′ can be constructed to fit over configurations such as oblong or rectangular.

FIG. 17 illustrates a protective cover, generally designated 170, in accordance with the invention having an elongated fold-over sheath-like configuration 171 with one end (171a) open and the other end 172 closed. The closed end may include an end tab 16 with a grommet 16a. In use, the open end 171a is slid over and envelopes the object to be covered.

FIG. 17A is a view of the cover 170 of FIG. 17 with the sheath-like member 170 slid over the elongated portion of a door handle 180 (shown in dotted lines).

FIG. 17B is a view of the cover 170 of FIG. 17 as used on a faucet handle 180 having an elongated portion 181 as shown in dotted lines.

FIG. 17C is a view of the cover of FIG. 17 as used on the flush handle 190 of a commode 191 having an elongated portion 192 as shown in dotted lines.

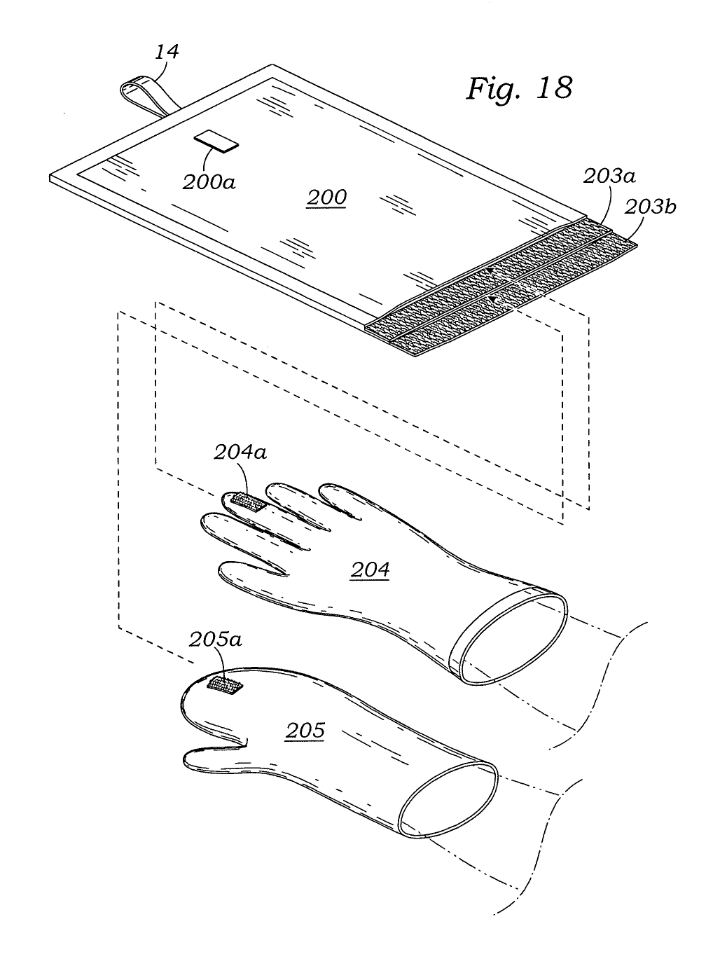

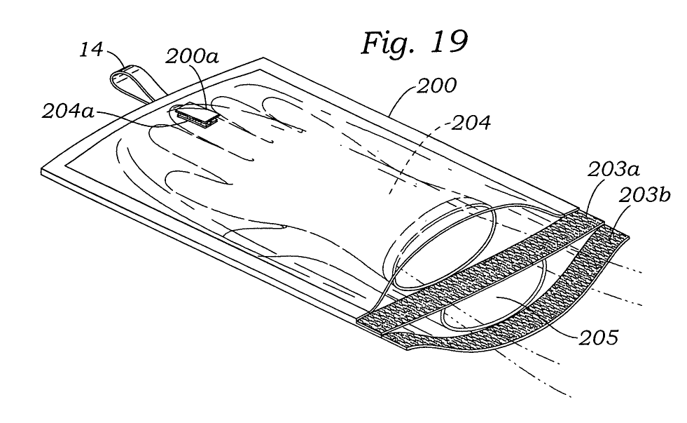

FIG. 18 is a view of an elongated sheath-like transparent protective cover 200 including two pockets 201,202 (better shown in FIG. 19), the pockets 201,202 closed by respective hook and pile closure means 203a, 203b. As indicated, each pocket is configured to accept a protective glove 204 or mitt 205. Each pocket includes either a hook or pile connective portion 200a with the gloves 204 and mitt 205 having the corresponding hook and pile connective portion for securing the glove 204 or mitt 205 within the cover 200. In this manner the gloves/mitts can be inserted and secured within the cover without the user touching them. It is understood that the hook and pile connections may be reversed so long as the glove 204 or mitt 205 is captured within the cover 200. After the gloves/mitts are secured within the cover 200 the cover 200 may be closed by means of hook and pile closure means 203a, 203b.

FIG. 19 is a perspective view of an elongated sheath-like protective cover 200 of FIG. 18 with a glove 204 inserted in each of the pockets 201, 202 with the hook and pile closure means in the open condition. The gloves 204 have a relaxed fit allowing them to be put on and taken off easily, and are large enough for use on top of regular winter or driving gloves. The gloves 204 help to protect against the hands of the user coming into contact with germs, infectious diseases and other contaminants present on the surfaces of objects. Gloves 204 are made of Neoprene which additionally helps to protect against absorption of oils, chemicals, grease and acids. They absorb perspiration to keep hands comfortable and dry, have denier polyester fabric banding around the top, and are thin and flexible enough to provide dexterity where needed to perform activities such as selection of gasoline grade, input bank card, and remove gas receipt. As designed, the glove 204 when used in combination with the cover 200, allows for the glove 204 to be put on and taken off without hands touching the outside of the glove, thereby helping to avoid contaminating the inside of the glove. The glove 204 can be used repeatedly as it can be washed with soap and water when needed and then dried before using.

The mitt 205 has an outer layer of flame resistant polyester and an inside layer, or lining, that is made of flame retardant and bacteria resistant Nylon. It also has a hook and pile strip 205a on the back that secures it within the cover 200, thus allowing for it to be put on and taken off without the hands touching the outside of the mitt 205. Mitt 205 is also thin and flexible enough to provide dexterity to perform activities that might otherwise be unsanitary or pose unwanted contamination. Mitt 205 can also be used repeatedly as it can also be washed with soap and water when needed.

It will be understood that variations, modifications, equivalents and substitutions for the invention as shown and described herein may be made by those skilled in the art without departing from the spirit and scope of the invention.

What is claimed is:

1. Hygienic apparatus for protecting hands from contaminated conditions taken from the group including; covers for handles, covers for gripping surfaces, protective gloves and mittens, and a cover for said gloves and mittens.

2. A protective hand cover in accordance with claim 1 comprising:
an elongated hollow generally tubular cover member;
a lengthwise slit running the length of said cover member;
said cover member is flexible and resilient allowing opening of said slit along the length of said member; and
whereby said slit is opened and said member is placed about a handle, after which said resilient cover member will spring back to firmly fit around said handle.

3. The hand cover in accordance with claim 2 wherein said cover member includes a transparent portion for viewing therethrough.

4. The hand cover in accordance with claim 3 wherein said cover member includes selectively positioned pull tabs for opening of said slit for placement of said member about said handle.

5. The hand cover in accordance with claim 4 wherein said cover member includes circumferential hook and pile means for secure closure of said cover member.

6. The hand cover in accordance with claim 4 wherein said cover member includes lengthwise hook and pile closure means along at least a portion of said slit for secure closure of said cover member.

7. A hand cover in accordance with claim 1 wherein said cover member comprises:
a flexible outer layer and a separate flexible inner layer, said inner layer comprising two portions each having extending center edges, said center edges separated by a slit; and
whereby said slit is opened by manipulation of said edges whereby said cover is fitted over the object to be covered.

8. A hand cover in accordance with claim 7 wherein said hand cover is substantially circular in configuration.

9. A hand cover in accordance with claim 1 comprising gloves wherein:
said gloves are thin and flexible thereby providing dexterity to perform normal activities such as selection of gasoline grade; and
said gloves have a relaxed fit and are sized to allow easy donning, removal and use over regular winter or driving gloves.

10. A hand cover in accordance with claim 9 wherein:
said gloves are made of material to provide protection to the user from exposure to chemicals, oils, grease and acids; and
said gloves are washable and thus can be used repeatedly.

11. A hand cover in accordance with claim 10 wherein said gloves are made of Neoprene.

12. A hand cover in accordance with claim 1 comprising mittens wherein:
said mittens include an outer layer of flame resistant polyester and an inside lining made of a flame and bacteria resistant material;
said mittens are thin and flexible to thereby provide dexterity for performing normal activities; and
said mittens are washable and can be used repeatedly.

13. A hand cover in accordance with claim 12 wherein said mittens are made of Nylon.

14. A cover in accordance with claim 1 wherein said cover for said gloves and mittens comprises:
an elongated sheath-like transparent protective cover including two pockets configured to accept either one of said glove or said mitten; and
said cover includes capture means in each of said pockets for securely enclosing said gloves and mittens therein.

15. A cover in accordance with claim 14 wherein said capture means includes in the interior of each of said pockets either a hook or pile connective portion with the said gloves and mittens having an exterior corresponding hook and pile connective portion for securing a glove or mitten within said cover, thereby providing means for inserting and securing said gloves and mittens within said cover without the user touching the outside of said gloves or said mittens;

16. A cover in accordance with claim 15 wherein said cover further includes connective means for secure closure of said gloves and said mittens within said cover.
